(19) United States
(12) Patent Application Publication
(10) Pub. No.: US 2016/0167512 A1
(43) Pub. Date: Jun. 16, 2016

(54) CONTROL PANEL FOR VEHICLE

(71) Applicant: HYUNDAI MOTOR COMPANY, Seoul (KR)

(72) Inventors: Sihyun JOO, Seoul (KR); Sung Un KIM, Yongin-si (KR); Jeong-Eom LEE, Yongin-si (KR); Jungsang MIN, Seoul (KR); Gi Beom HONG, Bucheon-si (KR)

(73) Assignee: HYUNDAI MOTOR COMPANY, Seoul (KR)

(21) Appl. No.: 14/799,556

(22) Filed: Jul. 14, 2015

(30) Foreign Application Priority Data
Dec. 11, 2014 (KR) 10-2014-0178378

(51) Int. Cl. B60K 35/00; B60K 37/06

(52) U.S. Cl. CPC B60K 35/00; B60K 37/06; B60K 2350/102; B60K 2350/1028; B60K 2350/1052

(57) ABSTRACT

A control panel for a vehicle may include: a vehicle speed detector configured to detect a vehicle speed; an input device including at least one of a dial knob, an omnidirectional trackball, and a touchpad; a display device configured to display a plurality of graphic objects; and a controller configured to determine whether the vehicle is in a stopped state or a running state based on the detected vehicle speed transmitted from the vehicle speed detector, select one of the plurality of graphic objects based on a input signal received from the input device, generate a control command for executing a function mapped to the input device, and output the control command to a corresponding control target device from among a plurality of control target devices. The controller may restrict an operation of the input device if the vehicle is in the running state.

### CROSS-REFERENCE TO RELATED APPLICATION

This application claims priority to and the benefit of Korean Patent Application No. 10-2014-0178378 filed in the Korean Intellectual Property Office on Dec. 11, 2014, the entire contents of which are incorporated herein by reference.

### TECHNICAL FIELD

The present disclosure relates to a control panel for a vehicle, and more particularly, to a control panel for a vehicle that can restrict an operation of an input device and modify a graphic object displayed on a display device according to a vehicle speed.

### BACKGROUND

Various electronic devices such as an audio video navigation (AVN) device, an air conditioner, and a head up display (HUD) device are mounted within a vehicle for a driver's convenience. Accordingly, the driver performs a large number of manipulations to search a desired function from among functions of the electronic devices. For example, when the driver searches for a destination, the driver selects the navigation device from among the electronic devices, searches a destination search menu of the navigation device, and then inputs a desired destination. The driver has to look at an input device and a display device to search the desired function while a vehicle is running, and thus driver's attention may be diverted from a road and the vehicle may deviate from a driving lane.

Therefore, there is a need for development of a control panel for minimizing diversion of a driver's attention so as to enable the driver to manipulate the electronic devices without disturbing driving.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a control panel that is capable of restricting operations of an input device and changing graphic objects displayed on a display device based on a vehicle speed.

A control panel for a vehicle according to an exemplary embodiment of the present invention may include: a vehicle speed detector configured to detect a vehicle speed; an input device including at least one of a dial knob, an omnidirectional trackball, and a touchpad; a display device configured to display a plurality of graphic objects; and a controller configured to determine whether the vehicle is in a stopped state or a running state based on the detected vehicle speed transmitted from the vehicle speed detector, select one of the plurality of graphic objects based on an input signal received from the input device, generate a control command for executing a function mapped to the selected graphic object, and output the control command to a corresponding control target device from among a plurality of control target devices. The controller may restrict an operation of the input device if the vehicle is in the running state.

If the vehicle is in the running state and the input device includes the dial knob capable of being tilted, rotated, and pushed, the controller may restrict a tilt operation of the dial knob via an actuator.

If the vehicle is in the running state and the input device includes the omnidirectional trackball capable of being scrolled omnidirectionally, the controller may permit only a vertical scroll operation and a lateral scroll operation via an actuator.

If the vehicle is in the running state and the input device includes the touchpad capable of detecting any of a single tap gesture input, a double tap gesture input, a swipe gesture input, a rotation gesture input, a pinch-in gesture input, a pinch-out gesture input, and a cursor movement gesture input, the controller may restrict the cursor movement gesture input.

If the state of the vehicle is changed from the stopped state to the running state, the controller may rearrange the plurality of graphic objects or deactivate a first predetermined function from among functions mapped to the plurality of graphic objects.

If the state of the vehicle is changed from the stopped state to the running state, the controller may modify a form of the graphic object corresponding to the first predetermined function.

If the detected vehicle speed is greater than or equal to a predetermined speed, the controller may deactivate the other functions except for a second predetermined function from among the functions mapped to the plurality of graphic objects.

A control panel for a vehicle according to an exemplary embodiment of the present invention may include: a vehicle speed detector configured to detect a vehicle speed; an input device including at least one of a dial knob, an omnidirectional trackball, and a touchpad; a display device configured to display a plurality of graphic objects; and a controller configured to determine whether the vehicle is in a stopped state or a running state based on the detected vehicle speed transmitted from the vehicle speed detector, select one of the plurality of graphic objects based on an input signal received from the input device, generate a control command for executing a function mapped to the selected graphic object, and output the control command to a corresponding control target device from among a plurality of control target devices. The controller may rearrange the plurality of graphic objects or deactivate a first predetermined function from among functions mapped to the plurality of graphic objects if a state of the vehicle is changed from the stopped state to the running state.

If the state of the vehicle is changed from the stopped state to the running state, the controller may modify a form of the graphic object corresponding to the first predetermined function.

If the detected vehicle speed is greater than or equal to a predetermined speed, the controller may deactivate the other functions except for a second predetermined function from among the functions mapped to the plurality of graphic objects.

A method for controlling a user command input device of a vehicle according to an exemplary embodiment of the present invention may include: detecting, by a speed detector integrated with the vehicle, a speed of the vehicle; determining, by a controller, whether the detected speed of the vehicle is greater than a first predetermined speed; and deactivating, by the controller, a first operation of the user command input device, upon determination that the detected speed of the vehicle is greater than the first predetermined speed.

The first predetermined speed may be equal to zero.

The method may further include: determining, by the controller, whether the detected speed of the vehicle is greater than a second predetermined speed, wherein the second predetermined speed is greater than the first predetermined speed; and further deactivating, by the controller, a second operation of the user command input device, upon determination that the detected speed of the vehicle is greater than the second predetermined speed.

The method may further include: rearranging, by the controller, a plurality of graphic objects displayed on a display of a vehicle, upon determination that the detected speed of the vehicle is greater than the first predetermined speed. The plurality of graphic objects may include one corresponding to the first operation of the user command input device.

The method may further include: modifying, by the controller, a form of a graphic object corresponding to the first operation of the user command input, upon determination that the detected speed of the vehicle is greater than the first predetermined speed.

The user command input device may be one selected from a group consisting of a dial knob, an omnidirectional trackball, and a touchpad.

According to an exemplary embodiment of the present invention, if the vehicle is in the running state, the operation of the input device is restricted and the graphic object displayed on the display device is changed, such that diversion of the driver's attention may be minimized.

### BRIEF DESCRIPTION OF THE DRAWINGS

FIG. 1 illustrates an interior of a vehicle including a control panel according to an exemplary embodiment of the present invention.

FIG. 2 is a block diagram of a control panel according to an exemplary embodiment of the present invention.

FIGS. 3A and 3B are drawings for explaining a method for rearranging graphic objects displayed on a display device according to an exemplary embodiment of the present invention.

FIG. 4 to FIG. 6 are drawings for explaining a method for deactivating a predetermined function from among functions mapped to graphic objects displayed on a display device according to an exemplary embodiment of the present invention.

### DETAILED DESCRIPTION

In the following detailed description, the present invention will be described more fully with reference to the accompanying drawings, in which exemplary embodiments of the invention are shown. However, the present invention is not limited to the exemplary embodiments which are described herein, and may be modified in various different ways.

Accordingly, the drawings and description are to be regarded as illustrative in nature and not restrictive. Like reference numerals designate like elements throughout the specification.

Since each component shown in the drawings is arbitrarily illustrated for easy description, the present invention is not particularly limited to the components illustrated in the drawings.

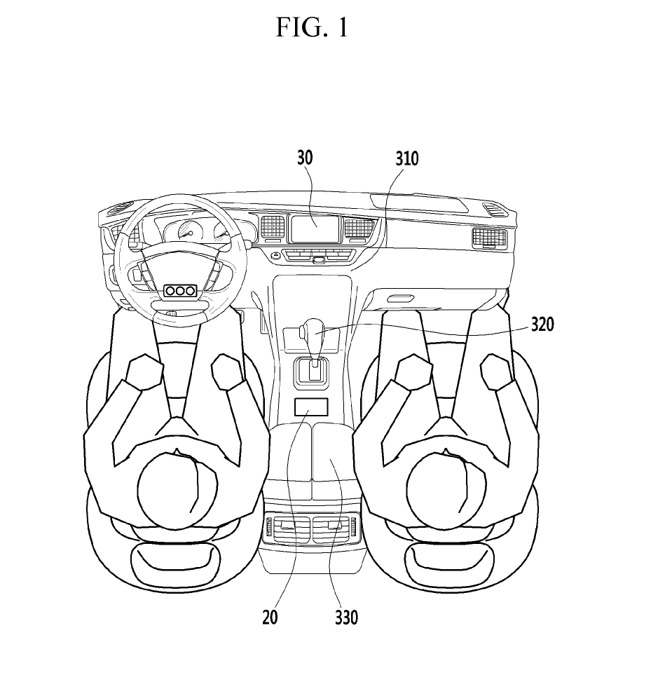

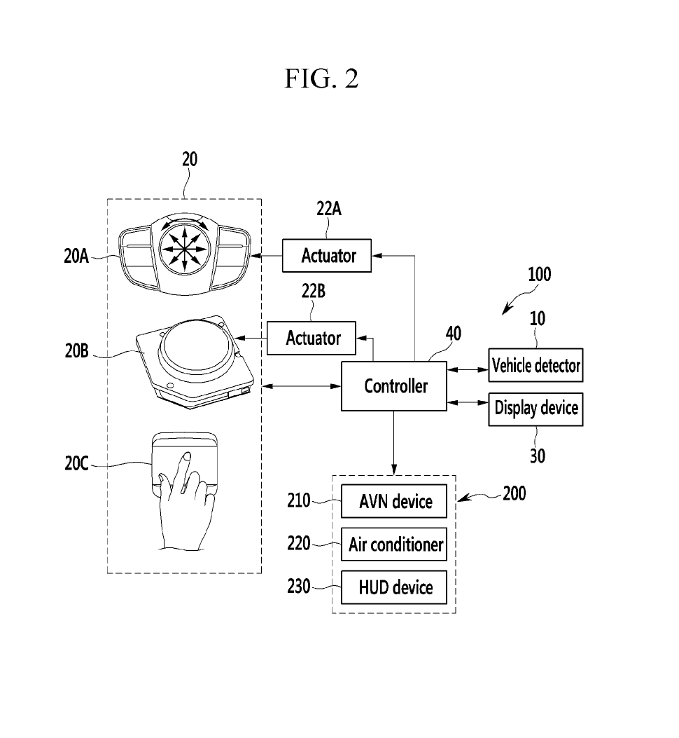

FIG. 1 illustrates an interior of a vehicle including a control panel according an exemplary embodiment of the present invention, and FIG. 2 illustrates a block control panel according to an exemplary embodiment of the present invention.

As shown in FIG. 1 and FIG. 2, a control panel 100 for a vehicle according to an exemplary embodiment of the present invention may include a vehicle speed detector 10, an input device 20, a display device 30, and a controller 40.

The vehicle speed detector 10 may be configured to detect a vehicle speed. The vehicle speed detector 10 may receive the vehicle speed from a vehicle speed sensor mounted at a wheel of the vehicle. Alternatively, the controller 40 may calculate the vehicle speed based on a GPS signal received by an audio video navigation (AVN) device 210. The controller 40 may determine whether the vehicle is in a stopped state or a running state based on the vehicle speed.

The input device 20 may be disposed in an appropriate position of the vehicle in order to enhance driver's convenience. For example, the input device 20 may be disposed in a partial area of a center fascia 310 or may be disposed in a partial area between a gear knob 320 and an arm rest 330. The input device 20 is manipulated by the driver, and transmits an input signal corresponding to the driver's manipulation to the controller 40.

The input device 20 may include at least one of a dial knob 20A, an omnidirectional trackball 20B, and a touchpad 20C. In addition, the input device 20 may further include at least one button.

The dial knob 20A may be tilted, rotated, and pushed by a user such as a driver. In particular, the dial knob 20A may perform a joystick function according to the tilt operation, a rotation dial function according to the rotation operation, and a button function according to the push operation. The dial knob 20A may be tilted in one of eight directions by the driver. Input signals corresponding to the tilt operation, the rotation operation, and the push operation are transmitted from the dial knob 20A to the controller 40.

The omnidirectional trackball 20B may be scrolled omnidirectionally. Input signals corresponding to a rotation direction and a speed of the trackball 20B are transmitted to the controller 40.

The touchpad 20C may detect any of a single tap gesture input, a double tap gesture input, a swipe gesture input, a rotation gesture input, a pinch-in gesture input, a pinch-out gesture input, a cursor movement gesture input, and the like. The single tap gesture input and the double tap gesture input may be realized when the driver's finger presses one spot of the touchpad 20C once or twice to select a graphic object displayed on the display device 30. The swipe gesture input may be realized when the driver's finger vertically and horizontally moves on the touchpad 20C. The rotation gesture input may be realized when the drive's finger rotates in a clockwise or counterclockwise direction on the touchpad 20C. The pinch-in gesture input may be realized when two fingers press two spots of the touchpad 20C simultaneously and move closer to each other from their initial positions. The pinch-out gesture input may be realized when two fingers press two spots of the touchpad 20C simultaneously and move away from each other from their initial positions. The cursor movement gesture input may be realized when the driver's finger contacting the touchpad 20C moves from one spot to another spot to move a cursor displayed on the display device 30. Input signals corresponding to the gesture inputs are transmitted to the controller 40.

The display device 30 may be a component of the AVN device 210 or a head up display (HUD) device 230. The display device 30 may display an image including information based on a display command of the controller 40. For example, the image may include AVN device information, air conditioner information, HUD device information, and the like. In particular, the image may include information indicating operation states of the AVN device 210, an air conditioner 220, and the HUD device 230, and a plurality of graphic objects that are selectable. A graphic object refers to information that is selected and controlled by the intention of the driver. For example, the graphic object may include an icon, text, contents, and a list.

The controller 40 may be implemented with one or more microprocessors executed by a predetermined program. The predetermined program may include a series of commands for performing each step included in a method for controlling the control panel according to an exemplary embodiment of the present invention.

The controller 40 is connected to a plurality of control target devices 200. For example, the plurality of control target devices 200 may include the AVN device 210, the air conditioner 220, and the HUD device 230. The controller 40 may generate control commands to execute functions of the plurality of control target devices 200, and output the control commands to a corresponding device. The functions may be various application functions of the plurality of control target devices. For example, the functions may be a destination search function of the AVN device 210, an air/temperature control function of the air conditioner 220, and a brightness control function of the HUD device 230. Functions of the plurality of control target devices 200 are mapped to the plurality of graphic objects displayed on the display device 30.

The controller 40 determines whether the vehicle is in a stopped state or a running state, and restricts the operation of the input device 20 if the vehicle is in the running state.

The controller 40 may restrict the tilt operation of the dial knob 20A via an actuator 22A. If the vehicle is in the stopped state and a precise manipulation such as a cursor movement is required, it is effective for the driver to use the tilt operation of the dial knob 20A. However, if the vehicle is in the running state and the tilt operation of the dial knob 20A is used, the driver needs to check the cursor movement, thereby disturbing safe driving. Accordingly, if the vehicle is in the running state, the controller 40 restricts the tilt operation of the dial knob 20A via the actuator 22A to prevent the driver's attention from being diverted.

The controller 40 may restrict the omnidirectional scroll operation of the trackball 20B via another actuator 22B. In particular, if the vehicle is in the running state, the controller 40 may permit only a vertical scroll operation and a lateral scroll operation of the trackball 20B. If the vehicle is in the running state and the omnidirectional scroll operation of the trackball 20B is allowed, the driver needs to check the cursor movement, thereby disturbing safe driving. Accordingly, if the vehicle is in the running state, the controller 40 restricts the omnidirectional scroll operation of the trackball 20B to prevent the driver's attention from being diverted.

The controller 40 may restrict the cursor movement gesture input of the touchpad 20C. If the vehicle is in the running state and the cursor movement gesture input is used, the driver needs to check the cursor movement, thereby disturbing safe driving. Accordingly, the controller 40 restricts the cursor movement gesture input of the touchpad 20C to prevent the driver's attention from being diverted.

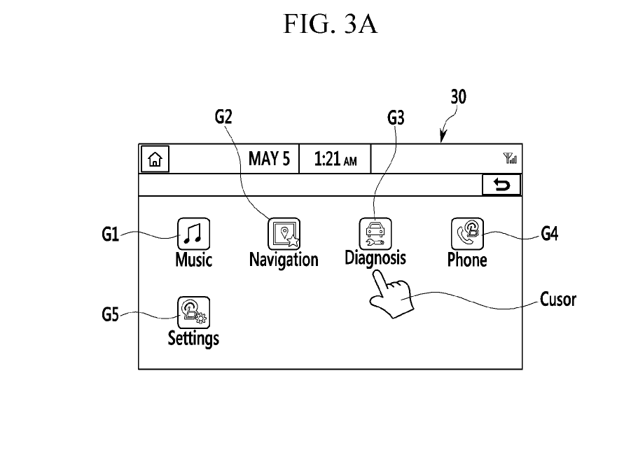

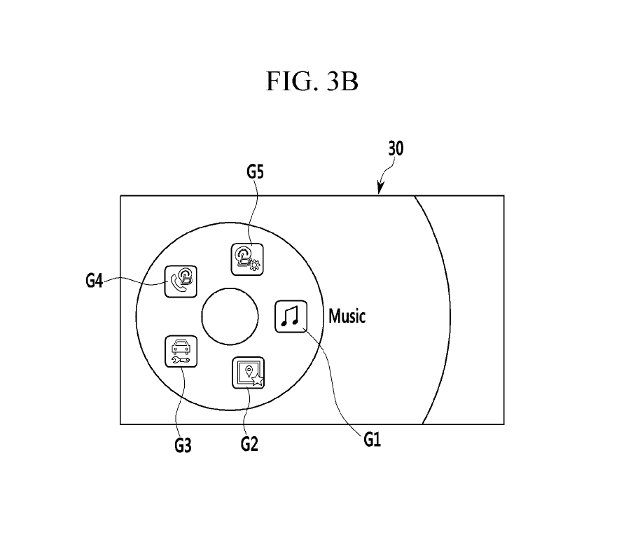

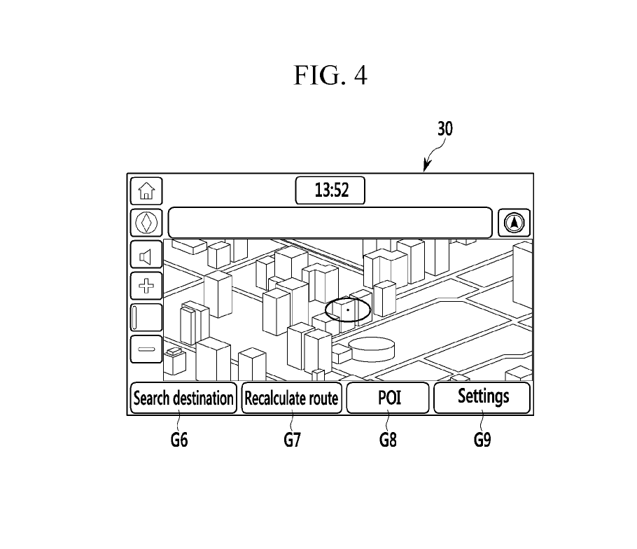

FIGS. 3A and 3B are drawings for explaining a method for rearranging graphic objects displayed on a display device according to an exemplary embodiment of the present invention, and FIG. 4 to FIG. 6 are drawings for explaining a method for deactivating a predetermined function from among functions mapped to graphic objects displayed on a display device according to an exemplary embodiment of the present invention.

As shown in FIG. 3A, the display device 30 may display a cursor and a plurality graphic objects G1, G2, G3, G4, and G5. The controller 40 selects one graphic object from among the plurality of objects G1, G2, G3, G4, and G5 based on the input signal received from the input device 20, and generates a control command to execute a function mapped to the selected graphic object. The controller 40 outputs the control signal to a corresponding control target device from among the plurality of control target devices 200. For example, the controller 40 may select the graphic object G1 based on a signal received from the input device 20, generate a control command for executing a function (i.e., a music play function) mapped to the graphic object G1, and output the control command to the AVN device 210.

The display device 30 may display the plurality of graphic objects G1, G2, G3, G4, and G5 in a matrix form. In order to execute the music play function, the driver should move the cursor to the graphic object G1 via the input device 20. Because the cursor movement needs to be checked by driver's eyes, the driver's attention may be diverted from the road.

Accordingly, if the state of the vehicle is changed from the stopped state to the running state, the controller 40 may rearrange the plurality of objects G1, G2, G3, G4, and G5 displayed on the display device 30. For example, as shown in FIG. 3B, the controller 40 may rearrange the plurality of objects G1, G2, G3, G4, and G5 such that the rotation operation of the dial knob 20A, the vertical direction scroll of the trackball 20B, and the rotation gesture input of the touchpad 20C may be easily realized.

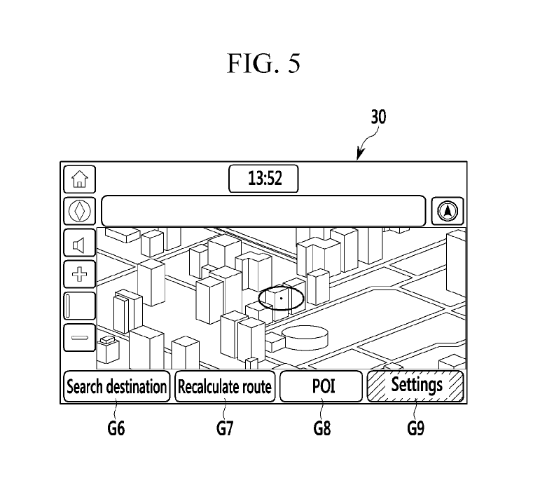

As shown in FIG. 4 to FIG. 6, when guiding a route, the display device 30 may display a plurality of graphic objects G6, G7, G8, and G9. If the state of the vehicle is changed from the stopped state to the running state, as shown in FIG. 5, the controller 40 may deactivate a first predetermined function from among functions mapped to the plurality of graphic objects G6, G7, G8, and G9. The first predetermined function may be a setting function such as a font size control function and a volume control function. That is, in consideration of safety of the driver, the controller 40 may restrict an access right to execute the function that requires a large number of manipulations. In this case, the controller 40 may modify a form of the graphic object G9 corresponding to the deactivated function. For example, the controller 40 may relatively darkly display the graphic object G9 corresponding to the deactivated function. Accordingly, if the state of the vehicle is changed from the stopped state to the running state, safety of the driver may be achieved by deactivating the first predetermined function that requires a large number of manipulations.

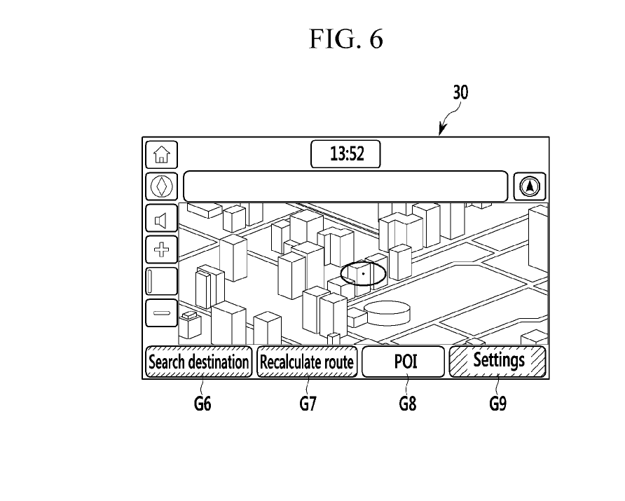

In addition, if the vehicle speed is greater than or equal to a predetermined speed, as shown in FIG. 6, the controller 40 may deactivate the other functions except for a second predetermined function (e.g., “recalculate route” function) from among the functions mapped to the graphic objects G6, G7, G8, and G9 displayed on the display device 30. The predetermined speed may be set to a speed (e.g., 30 km/h) which is determined by a person of ordinary skill in the art. That is, if the vehicle speed is greater than or equal to the predetermined speed, the controller 40 may restrict access rights to execute the other functions, except the second function that requires only one manipulation. In this case, the controller 40 may relatively darkly display the graphic objects G6, G8, and G9 corresponding to the deactivated function. Accordingly, the deactivated function may be determined based on the vehicle speed, thereby minimizing diversion of driver's attention.

As described above, according to an exemplary embodiment of the present invention, if the vehicle is in the running state, the operation of the input device 20 is restricted and the graphic object displayed on the display device 30 is changed, such that diversion of the driver's attention may be minimized. In addition, it is possible to provide convenience and safety of driving.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A control panel for a vehicle, comprising:
a vehicle speed detector configured to detect a vehicle speed;
an input device including at least one of a dial knob, an omnidirectional trackball, and a touchpad;
a display device configured to display a plurality of graphic objects; and
a controller configured to determine whether the vehicle is in a stopped state or a running state based on the detected vehicle speed transmitted from the vehicle speed detector, select one of the plurality of graphic objects based on an input signal received from the input device, generate a control command for executing a function mapped to the selected graphic object, and output the control command to a corresponding control target device from among a plurality of control target devices,
wherein the controller restricts an operation of the input device if the vehicle is in the running state.

2. The control panel of claim 1, wherein, if the vehicle is in the running state and the input device includes the dial knob capable of being tilted, rotated, and pushed, the controller restricts a tilt operation of the dial knob via an actuator.

3. The control panel of claim 1, wherein, if the vehicle is in the running state and the input device includes the omnidirectional trackball capable of being scrolled omnidirectionally, the controller permits only a vertical scroll operation and a lateral scroll operation via an actuator.

4. The control panel of claim 1, wherein, if the vehicle is in the running state and the input device includes the touchpad capable of detecting any of a single tap gesture input, a double tap gesture input, a swipe gesture input, a rotation gesture input, a pinch-in gesture input, a pinch-out gesture input, and a cursor movement gesture input, the controller restricts the cursor movement gesture input.

5. The control panel of claim 1, wherein, if a state of the vehicle is changed from the stopped state to the running state, the controller rearranges the plurality of graphic objects or deactivates a first predetermined function from among functions mapped to the plurality of graphic objects.

6. The control panel of claim 5, wherein, if the state of the vehicle is changed from the stopped state to the running state, the controller modifies a form of the graphic object corresponding to the first predetermined function.

7. The control panel of claim 5, wherein, if the vehicle speed is greater than or equal to a predetermined speed, the controller deactivates the other functions except for a second predetermined function from among the functions mapped to the plurality of graphic objects.

8. A control panel for a vehicle, comprising:
a vehicle speed detector configured to detect a vehicle speed;
an input device including at least one of a dial knob, an omnidirectional trackball, and a touchpad;
a display device configured to display a plurality of graphic objects; and
a controller configured to determine whether the vehicle is in a stopped state or a running state based on the detected vehicle speed transmitted from the vehicle speed detector, select one of the plurality of graphic objects based on an input signal received from the input device, generate a control command for executing a function mapped to the selected graphic object, and output the control command to a corresponding control target device from among a plurality of control target devices,
wherein the controller rearranges the plurality of graphic objects or deactivates a first predetermined function from among functions mapped to the plurality of graphic objects if a state of the vehicle is changed from the stopped state to the running state.

9. The control panel of claim 8, wherein, if the state of the vehicle is changed from the stopped state to the running state, the controller modifies a form of the graphic object corresponding to the first predetermined function.

10. The control panel of claim 8, wherein, if the vehicle speed is greater than or equal to a predetermined speed, the controller deactivates the other functions except for a second predetermined function from among the functions mapped to the plurality of graphic objects.

11. A method for controlling a user command input device of a vehicle, the method comprising:
detecting, by a speed detector integrated with the vehicle, a speed of the vehicle;
determining, by a controller, whether the detected speed of the vehicle is greater than a first predetermined speed; and
deactivating, by the controller, a first operation of the user command input device, upon determination that the speed of the vehicle is greater than the first predetermined speed.

12. The method of claim 11, wherein the first predetermined speed is zero.

13. The method of claim 11, further comprising:
determining, by the controller, whether the detected speed of the vehicle is greater than a second predetermined speed, wherein the second predetermined speed is greater than the first predetermined speed; and
further deactivating, by the controller, a second operation of the user command input device, upon determination that the detected speed of the vehicle is greater than the second predetermined speed.

14. The method of claim 11, further comprising:
rearranging, by the controller, a plurality of graphic objects displayed on a display of a vehicle, upon determination that the detected speed of the vehicle is greater than the first predetermined speed,
wherein the plurality of graphic objects includes one corresponding to the first operation of the user command input device.

15. The method of claim 11, further comprising:
modifying, by the controller, a form of a graphic object corresponding to the first operation of the user command input, upon determination that the detected speed of the vehicle is greater than the first predetermined speed.

16. The method of claim 11, wherein the user command input device is one selected from a group consisting of a dial knob, an omnidirectional trackball, and a touchpad.
